(19) United States
(12) Patent Application Publication
(10) Pub. No.: US 2009/0218851 A1
(43) Pub. Date: Sep. 3, 2009

(54) MOTOR VEHICLE WITH PROTECTION FOR A REAR-HINGED SIDE DOOR

(75) Inventors: Alastair ANDERSON, Wiesbaden (DE); Karl-Franz HEDRICH, Saulheim (DE); Gunther HEIM, Lampertheim (DE); Thomas ENDERICH, Hunstetten (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/392,754

(22) Filed: Feb. 25, 2009

(30) Foreign Application Priority Data
Feb. 25, 2008 (DE) 102008010922.3

(51) Int. Cl. B60J 5/04

(52) U.S. Cl. 296/187.03

(57) ABSTRACT

A motor vehicle is provided that includes, but is not limited to with a front-hinged front door and rear-hinged rear door located on the same vehicle side, and front door and rear door each have an impact block arranged in such a manner that the blocks are pushed against each other during a front-end collision.

### CROSS-REFERENCE TO RELATED APPLICATION

This application claims priority to German Patent Application No. 102008010922.3, filed Feb. 25, 2008, which is incorporated herein by reference in its entirety.

### TECHNICAL FIELD

The invention relates to a motor vehicle door, in particular a passenger car, with a rear-hinged side door.

### BACKGROUND

On a conventional motor vehicle, the side doors are each front-hinged (i.e., the front door on the A-pillar and the rear door on the B-pillar). At a collision taking place in longitudinal direction of the vehicle it can happen that the front side door is pushed against the rear side door or vice versa. To ensure that even after a heavy collision, the front door can still be opened, the rear door can have an extending impact bar in the area of the B-pillar. During the normal driving operation, the impact bar allows that front and rear doors can be opened and closed independently. During a movement of the two side doors towards one another caused by a collision, the impact bar shifts as intended underneath a section of the front door. Thereby is prevented that in case of further deformation in longitudinal direction of the vehicle, the rear door is pushed over the front door and consequently blocks the front door. On motor vehicles on which the rear door is rear-hinged, such an impact bar is not usable since the same would prevent that the side doors can be opened and closed independently from each other.

In view of the foregoing, at least one object of an embodiment of the invention to provide a motor vehicle with a rear-hinged rear door, and in the case of a collision taking place in longitudinal direction of the vehicle, a blocking of the front door by the rear door (or vice versa) is prevented. In addition, other objects, desirable features, and characteristics will become apparent from the subsequent summary and detailed description, and the appended claims, taken in conjunction with the accompanying drawings and this background.

### SUMMARY

A first embodiment of the motor vehicle has a front-hinged front door and a rear-hinged rear door located on the same side of the vehicle. Front door and rear door each have an impact block. The two impact blocks are arranged or positioned, respectively, in such a manner that they are pushed against each other during a sufficiently heavy front-end collision or rear-end collision.

In this embodiment, the front door and the assigned rear door each have at least one impact block. In the case of a front-end collision or rear-end collision, the impact blocks assigned to each other are moved towards each other and are pushed against each other in the case of a sufficiently heavy collision. The impact blocks then keep a distance between the side doors, thereby preventing that the rear door shifts laterally over the front door or vice versa so that a blocking of the side doors caused by the collision is prevented.

In a second embodiment, the two impact blocks have planar outer faces facing one another. In the case of a motor vehicle collision with a collision from the front or from behind, the two outer faces abut flatly against each other. This reduces the risk that the two impact blocks can laterally slide past each other or slip-off laterally. This is also achieved with relatively small outer faces facing each other so that with this formation, the impact blocks can be designed smaller. Hence it is easier to find a suitable position for the impact blocks and an optimal position for the intended function. At the same time, this allows a wider scope for the decision if the impact blocks should optically stand out in a striking manner, thereby contributing to highlight the esthetic overall impression of the motor vehicle.

In a further embodiment, which can be combined with the latter embodiment as well as with the embodiments below, the impact blocks are located at the level of the door shaft and hence at the level of the load path. Thereby the danger is reduced that during the collision the impact blocks are moved past each other due to shearing.

According to a further embodiment, the impact blocks are located at the level of the belt line of the motor vehicle. At this level, they are, as in the last mentioned embodiment, close to the load path, and a fastening position on the inner door wall can easily be found.

According to a further embodiment, the smallest distance between the impact blocks, measured in longitudinal direction of the vehicle, is, at the most, as big as the door joint between the front and rear door is wide. Thus, the two side doors are kept at a distance to each other before they abut against each other due to the collision at the closest position. In the case of an only minor collision, thereby can be prevented that the two side doors abut against each and damage themselves. Thereby there is the potential that the repair costs are kept lower and, where applicable, the automobile insurance becomes more inexpensive.

In a concretization of one of the embodiments above, the impact blocks can consist of plastic and can rest form-fitting against the inner door wall. The plastic material allows a free color selection for an optimized design and allows a fastening without any problems and without damaging the lacquer. The shape of the impact blocks, regardless if made from plastic or not, is, to a large extent, freely selectable as long as it is ensured that in the case of a collision, the impact blocks abut against each other in longitudinal direction of the vehicle and keep the two side doors at a distance to each other. The plastic, for example polyamide, can be fiber-reinforced here for the purpose of improved mechanical load capacity.

### BRIEF DESCRIPTION OF THE DRAWINGS

The present invention will hereinafter be described in conjunction with the following drawing figures, wherein like numerals denote like elements, and:

FIG. 1 shows a motor vehicle with a rear-hinged side door;

FIG. 2 shows the installation area of the impact block on the front side door; and

FIG. 3 shows the installation area of the impact block with closed side doors.

### DETAILED DESCRIPTION

The following detailed description is merely exemplary in nature and is not intended to limit application and uses. Furthermore, there is no intention to be bound by any theory presented in the preceding background or summary or the following detailed description.

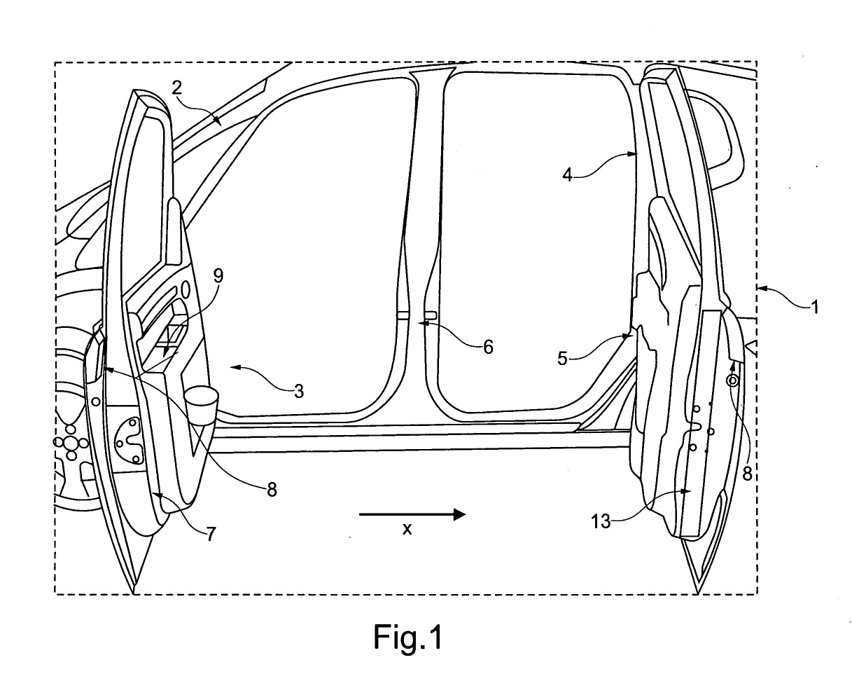

In the figures which, in general, denote with the same reference numbers the same objects, FIG. 1 shows a motor vehicle 1 with a front-hinged front door 3 (i.e., hinged on the A-pillar 2) and a rear-hinged rear door 5 (i.e., hinged on the C-pillar 4), and with the B-pillar 6 located there between. The arrow x points from the front rearwards in longitudinal direction of the vehicle. The front door 3 and the rear door 5 each have one impact block 8 which rests form-fitting on the inner door wall 7 at the level of the door shaft 13, here at the level of the belt line 9.

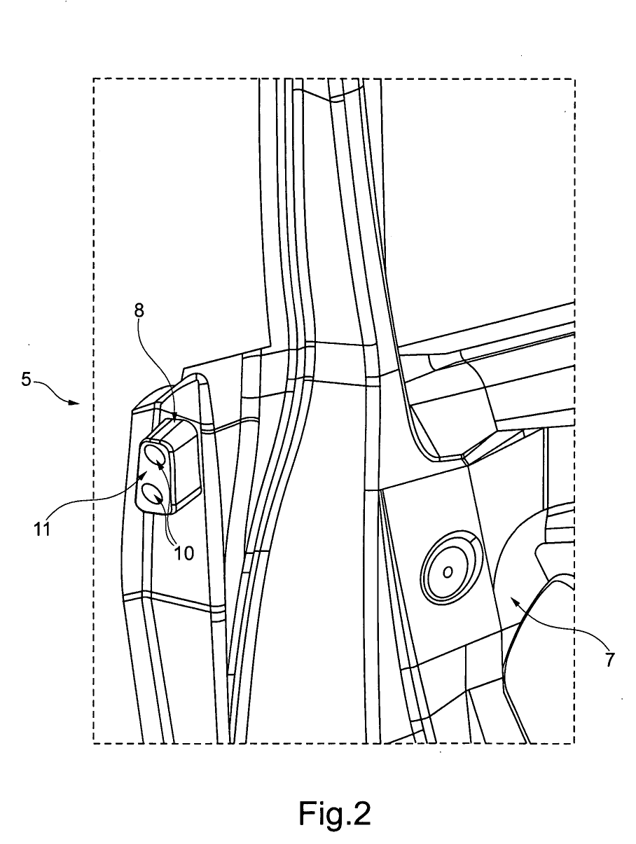

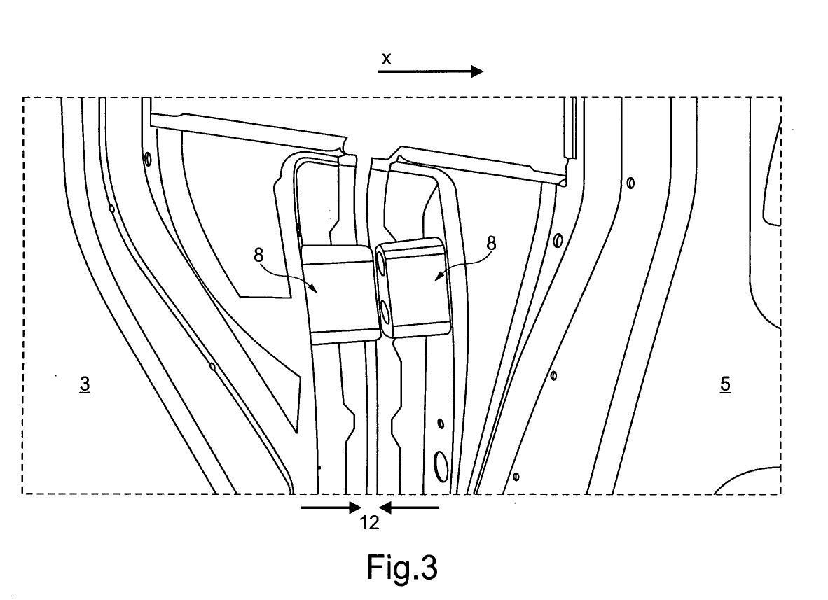

FIG. 2 shows the fastening area of impact block 8 of the front door 3 in detail. The impact block 8 is structurally modified compared to the variant in FIG. 1 and has the shape of an elongated block which is screwed to the inner door wall 7 by means of two screw holes 10. The impact block 8 consists of polyamide with a fiber glass portion of 33% by weight. It has a planar outer face 11 (see FIG. 3) which when the side doors are closed, is parallel to the corresponding outer face 11 of the impact block 8 of the rear door 5. The distance of the two outer faces 11 is here exactly as wide as the width of the door joint 12 measured in longitudinal direction of the vehicle. If a front-end collision occurs, the impact block 8 of the front door 3 is pushed in x-direction towards the rear door 5 until the two impact blocks 8 abut against each other.

Thereby, front door 3 and rear door 5 are kept at a distance from each other, and hence it is prevented that the front door 3 partly shifts laterally over the rear door 5, or, in the case of a collision from the rear side, vice versa, the rear door 5 over the front door 3.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A motor vehicle, comprising:
a front-hinged front door;
a rear-hinged rear door located on the same side of the motor vehicle as the front-hinged front door;
an first impact block for the front-hinged front door; and
a second impact block for the rear-hinged rear door,
wherein the first impact block and the second impact block are arranged such that the first impact block and the second impact block are pushed against each other during a front-end collision.

2. The motor vehicle according to claim 1, wherein the first impact block and the second impact block have planar outer faces facing each other.

3. The motor vehicle according to claim 1, wherein the first impact block and the second impact block are located at a level of a door shaft.

4. The motor vehicle according to claim 1, wherein the first impact block and the second impact block are located at a level of a belt line of the motor vehicle.

5. The motor vehicle according to claim 1, wherein a smallest distance between the first impact block and the second impact block, measured in a longitudinal direction of the motor vehicle, is at most as large as a door joint is wide.

6. The motor vehicle according to claim 1, wherein the first impact block and the second impact block are plastic blocks that rest against an inner door wall in a form-fitting manner.

7. The motor vehicle according to claim 1, wherein at least one of the first impact block or the second impact block is made from a fiber-reinforced plastic.
